(19) United States
(12) Patent Application Publication
(10) Pub. No.: US 2008/0113071 A1
(43) Pub. Date: May 15, 2008

(54) POLY N-VINYL PYRROLIDONE

(76) Inventor: Jeffrey M. Cohen, San Diego, CA (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 11/559,078

(22) Filed: Nov. 13, 2006

(51) Int. Cl. C12H 1/00; C08F 126/06

(52) U.S. Cl. 426/422; 525/540

(57) ABSTRACT

The present invention provides for compositions comprising poly N-vinyl pyrrolidone (PVPP) with improved capability to remove polyphenols, methods of producing and using the same. Producing the PVPP with improved capability to remove polyphenols may comprise adding a quantity of hydrogen peroxide to a composition comprising the PVPP, mixing the hydrogen peroxide and the composition comprising the PVPP and removing from the mixture, the PVPP with improved capability to remove polyphenols. The PVPP with improved capability to remove polyphenols may be useful for reducing the formation of colloidal haze in beverages such as beer.

### FIELD OF INVENTION

This invention relates to compositions comprising crosslinked poly N-vinyl pyrrolidone (PVPP) with improved ability to reduce the amount of colloidal haze that forms in beverages and methods of producing and using the same.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

The reaction that produces poly N-vinyl pyrrolidone (PVPP) is the proliferous polymerization of N-vinyl pyrrolidone in the presence of a bifunctional monomer that acts as a crosslinker, forming links between polymer chains. The resulting polymer is insoluble in water, but will swell slightly when suspended in water. The degree of swelling is a function of the density of the crosslinks; the higher the crosslink density, the less the polymer will swell.

Two basic processes are practiced commercially. The first forms the crosslinker in situ from the N-vinyl pyrrolidone monomer and the second adds a bifunctional monomer that is not derived from N-vinyl pyrrolidone.

U.S. Pat. No. 2,938,017 reveals that insoluble polymer may be obtained from N-vinyl pyrrolidone by heating the monomer to between 100 and 150° C., in the presence of alkaline or alkaline earth oxides or hydroxides. During polymerization the temperature of the reaction mass reaches 200° C.

This method proved difficult to control and was refined in U.S. Pat. Nos. 3,277,066 and 3,306,886. In these patents, processes are disclosed for the manufacture of insoluble (crosslinked) poly N-vinyl pyrrolidone in which the monomer is heated to around 140° C., in the presence of water and a catalyst such as alkali metal hydrides, alkali metal borohydrides and/or alkaline earth metal hydroxides or alkoxides until the polymerization has started, whereupon the reaction mass is cooled to 80° C. and held between 80 and 100° C. until the reaction is complete. The presence of water requires that the reaction be carried out in a pressure vessel.

The use of a bifunctional monomer is first disclosed in U.S. Pat. No. 3,759,880. The objective of the '880 Patent is to avoid the high pressure associated with the in situ method. In this process, a seed batch was prepared comprising equal amounts of water and N-vinyl pyrrolidone which were added to a reactor along with about 2% of N,N′-divinylimidazolidone (based on N-vinyl pyrrolidone). Iron turnings and dibenzoyl peroxide are added to the mixture and heated to between 30 and 35° C. After about 2 hours, insoluble polymer seeds begin to appear and grow at an increasing rate with the reaction temperature peaking at 102° C. At the same time, the main batch charge is prepared. The main batch is 100 times the size of the seed batch with the proportions of water, N-vinyl pyrrolidone and N,N′-divinylimidazolidone the same as the seed batch. The main batch is heated to 80° C., at which time the seed batch is added to the main batch. When the seed batch is added to the main batch, further polymerization is initiated, causing the temperature to rise to the reflux temperature of the mixture (about 102° C.) and allowed to boil under reflux. The polymerization is complete after about 20 minutes.

All of the above patents reference the clarification of beer as a use for the insoluble, crosslinked poly-N-vinyl pyrrolidone. In practice, materials made by either process have been used interchangeably for beer clarification.

In commercial production, the manufacturing process for recovering the dry polymer is essentially the same for either polymerization method.

The reaction mass is slurried in water at about 15% solids. The solids are filtered and washed with water to remove impurities, then slurried again in water at about 15% solids. The second slurry is fed to a spray dryer and the dry solid product is recovered.

The ability of PVPP to absorb phenols was described in U.S. Pat. No. 3,689,439. Salicylic acid was used as a model compound to demonstrate the ability of PVPP to absorb compounds with a phenolic moiety from aqueous solution.

This has led to a more detailed description of the mechanism of haze development in beer and how PVPP acts to reduce the amount of colloidal haze that forms in beer.

Acidic proteins and simple polyphenol compounds, called flavonoids, are present in freshly brewed beer. The flavonoids and the proteins associate by hydrogen bonding, but the molecular weight of these complexes is too low to form visible colloidal haze.

During the first 3 to 6 weeks of storage, the flavonoids in the beer have oxidized and polymerized to form materials called tannoids that consist of 3 to 5 units of flavonoids. These longer chain polyphenols are capable of forming hydrogen bonds with several protein molecules at a time, thus forming complexes of a sufficiently high molecular weight to form a colloid that is visible to the human eye. The hydrogen bonds will reversibly disassociate at temperatures above 35° C., but will be visible at temperatures below 10° C. As a result, this phenomenon is known as “chill haze”.

After further storage, tannoids begin to form covalent and ionic bonds with proteins. This leads to even larger colloidal particles that are stable above 35° C. and therefore will not dissociate upon heating. This is termed “permanent haze”.

As noted above, PVPP absorbs phenolic compounds from aqueous media. Thus, treatment with PVPP removes flavonoids, which are phenolic, from the beer. Since the flavonoids are removed, they cannot form tannoids, and without tannoids, there is nothing to complex with the acidic proteins, hence no colloid formation and neither “chill haze” nor “permanent haze” can form.

The actual method by which PVPP is used in treating beer may be as follows: Dry PVPP is allowed to hydrate by slurring it in water at a concentration of 8 to 12% solids for a period of 1 hour. The PVPP slurry is added to the beer to make a concentration of between 5 and 50 grams of PVPP per hectoliter of beer. The PVPP is then filtered out of the beer which is then packaged in cans, bottles or kegs.

There have been attempts to improve the efficacy of PVPP in the treatment of beer; for example, in U.S. Pat. No. 5,094,867, a comonomer, N-vinylimidazole, was polymerized with N-vinyl pyrrolidone using N,N′-divinylethyleneurea as the crosslinker. In the '867 Patent, removal of heavy metals from wine was claimed. However, this material has not had any significant impact on the practice of beer stabilization. In fact, PVPP, produced as described in U.S. Pat. No. 3,759,880 by adding a crosslinker or as described in U.S. Pat. Nos. 3,277,066 and 3,306,886 remains the dominant commercial product.

Therefore, there is a need in the art to provide a process to improve the ability of PVPP to remove polyphenolic flavonoids from beer, thereby increasing the shelf life of beer, wine and other beverages.

### SUMMARY OF THE INVENTION

The following embodiments and aspects thereof are described and illustrated in conjunction with compositions and methods which are meant to be exemplary and illustrative, not limiting in scope.

Embodiments of the present invention include, but are not limited to, methods of producing a poly N-vinyl pyrrolidone (PVPP) with improved capability to absorb and/or remove polyphenols and/or with improved capability to reduce the amount of colloidal haze that may form in a beverage; kits for the same; compositions comprising the PVPP with improved capability to absorb and/or remove polyphenols and/or with improved capability to reduce the amount of colloidal haze that may form in a beverage; methods of removing polyphenols from a beverage and/or reducing the amount of colloidal haze that may form in a beverage; and kits for the same.

In one embodiment, methods of producing a poly N-vinyl pyrrolidone (PVPP) with improved capability to absorb and/or remove polyphenols and/or with improved capability to reduce the amount of colloidal haze that may form in a beverage (“improved PVPP”), comprises: providing a composition comprising PVPP; adding a quantity of hydrogen peroxide to the composition; generating a slurry; mixing the slurry; and removing from the slurry, the improved PVPP. The polyphenols may comprise a polyphenolic flavonoid. The composition comprising PVPP may be a reaction mass comprising PVPP, a filter cake comprising PVPP, a slurry comprising PVPP and combinations thereof.

In one embodiment, the quantity of hydrogen peroxide may bring the concentration of hydrogen peroxide in the slurry to from about 0.5% to about 5%. In another embodiment, the quantity of hydrogen peroxide may bring the concentration of hydrogen peroxide in the slurry to from about 1% to about 3%.

In another embodiment, the method may further comprise washing the filter cake comprising PVPP with the quantity of hydrogen peroxide. In another embodiment, the method further comprises drying the improved PVPP. Drying the improved PVPP may comprise spray drying the PVPP.

Other embodiments provide for compositions, comprising a poly N-vinyl pyrrolidone (PVPP) with improved capability to absorb and/or remove polyphenols and/or with improved capability to reduce the amount of colloidal haze that may form in a beverage (“improved PVPP”), produced by a method comprising: providing a composition comprising PVPP; adding a quantity of hydrogen peroxide to the composition; generating a slurry; mixing the slurry; and removing from the slurry, the improved PVPP. In one embodiment, the method may further comprise washing the filter cake comprising PVPP with the hydrogen peroxide. In another embodiment, the method may further comprise drying the improved PVPP. In another embodiment, the method may further comprise spray drying the improved PVPP.

The polyphenols may comprise a polyphenolic favonoid. The composition comprising PVPP may be a reaction mass comprising PVPP, a filter cake comprising PVPP, a slurry comprising PVPP and combinations thereof.

In one embodiment, the quantity of hydrogen peroxide may bring the concentration of hydrogen peroxide in the slurry to from about 0.5% to about 5%. In another embodiment, the quantity of hydrogen peroxide may bring the concentration of hydrogen peroxide in the slurry to from about 1% to about 3%.

Additional embodiments of the present invention provide for methods of removing a polyphenol from a beverage and/or reducing the amount of colloidal haze that may form in a beverage, comprising: providing a composition comprising a poly N-vinyl pyrrolidone (PVPP) with improved capability to absorb and/or remove polyphenols and/or with improved capability to reduce the amount of colloidal haze that may form in a beverage (“improved PVPP”), produced by a method comprising: providing a composition comprising PVPP, adding a quantity of hydrogen peroxide to the composition, generating a slurry, mixing the slurry, and removing from the slurry, the improved PVPP; adding to the beverage, a quantity of the composition comprising the improved PVPP; mixing the composition comprising the improved PVPP and the beverage; and removing from the beverage, the composition comprising the improved. In one embodiment, method of producing the composition may further comprise washing the filter cake comprising PVPP with the hydrogen peroxide. In another embodiment, the method of producing the composition may further comprise drying the improved PVPP. In another embodiment, the method of producing the composition may further comprise spray drying the improved PVPP.

The polyphenols may comprise a polyphenolic flavonoid. In one embodiment, the beverage may be beer. In another embodiment, the beverage may be wine. The composition comprising PVPP may be a reaction mass comprising PVPP, a filter cake comprising PVPP, a slurry comprising PVPP and combinations thereof. In one embodiment, the quantity of hydrogen peroxide may bring the concentration of hydrogen peroxide in the slurry to from about 0.5% to about 5%. In another embodiment, the quantity of hydrogen peroxide may bring the concentration of hydrogen peroxide in the slurry to from about 1% to about 3%.

Still additional embodiments of the present invention provide for kits for producing a poly N-vinyl pyrrolidone (PVPP) with improved capability to absorb and/or remove polyphenols and/or with improved capability to reduce the amount of colloidal haze that may form in a beverage (“improved PVPP”), comprising: a quantity of PVPP; a quantity of hydrogen peroxide; and instructions to use the PVPP and the hydrogen peroxide to produce the composition comprising the improved PVPP. The instructions may comprise instructions to add a quantity of hydrogen peroxide to the PVPP, generating a slurry comprising the PVPP and the hydrogen peroxide, mix the slurry comprising the PVPP and the hydrogen peroxide, remove from the slurry, the improved PVPP, and dry the improved PVPP. The instructions may further comprise instructions to wash the PVPP with the hydrogen peroxide.

The instructions to add the quantity of hydrogen peroxide may comprise instructions to add a quantity of hydrogen peroxide that brings the concentration of hydrogen peroxide in the slurry to from about 0.5% to about 5% and/or instructions to add a quantity of hydrogen peroxide that brings the concentration of hydrogen peroxide in the slurry to from about 1% to about 3%. The polyphenols to be removed by the kit may comprise a polyphenolic flavonoid.

Further embodiments of the present invention provide for kits for removing a polyphenol from a beverage and/or reducing the amount of colloidal haze that may form in a beverage, comprising: providing a composition comprising a poly N-vinyl pyrrolidone (PVPP) with improved capability to absorb and/or remove polyphenols and/or with improved capability to reduce the amount of colloidal haze that may form in a beverage (“improved PVPP”) produced by a method comprising: providing a composition comprising PVPP; adding a quantity of hydrogen peroxide to the composition; generating a slurry; mixing the slurry; and removing from the slurry, the improved PVPP; and instructions to use the composition comprising the improved PVPP to remove the polyphenol from the beverage and/or reduce the amount of colloidal haze that may form in the beverage. In one embodiment, the method of producing the composition may further comprise washing the composition comprising PVPP with the hydrogen peroxide.

The instructions may comprise instructions to add to the beverage, a quantity of the composition comprising the improved PVPP, mix the composition comprising the improved PVPP and the beverage, and remove from the beverage, the composition comprising the improved PVPP.

In one embodiment, the polyphenol to be removed by the kit may comprise a polyphenolic flavonoid.

In one embodiment, the beverage to be treated by the kit may be beer. In another embodiment, the beverage to be treated by the kit may be wine.

Other features and advantages of the invention will become apparent from the following detailed description, taken in conjunction with the accompanying drawings, which illustrate, by way of example, various features of embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 illustrates a flow chart of a method of producing PVPP with improved capability to absorb and/or remove polyphenols in accordance with various embodiments of the present invention. A quantity of hydrogen peroxide when the reaction mass is initially slurried in water or the reaction mass is slurried a hydrogen peroxide-water solution.

FIG. 2 illustrates a flow chart of a method of producing PVPP with improved capability to absorb and/or remove polyphenols in accordance with an embodiment of the present invention. The filter cake, which is generated after the second slurry is filtered, is washed with a quantity of hydrogen peroxide.

FIG. 3 illustrates a flow chart of a method of producing PVPP with improved capability to absorb and/or remove polyphenols in accordance with various embodiments of the present invention. A quantity of hydrogen peroxide is added after the filter cake is reslurried or the filter cake reslurried in a hydrogen peroxide-water solution.

FIG. 4 illustrates a flow chart of a method of producing PVPP with improved capability to absorb and/or remove polyphenols in accordance with an embodiment of the present invention. The final dry product is treated with hydrogen peroxide by slurrying it in a solution comprising a quantity of hydrogen peroxide.

FIG. 5 illustrates a flow chart of a method of producing PVPP with improved capability to absorb and/or remove polyphenols in accordance with various embodiments of the present invention. A quantity of hydrogen peroxide is added during one or more steps in the process of producing the PVPP.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. March, Advanced Organic Chemistry Reactions, Mechanisms and Structure 5^{th} ed., J. Wiley & Sons (New York, N.Y. 2001) may provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

“Improved PVPP” as used herein refers to PVPP with improved capability to absorb and/or remove polyphenols and/or PVPP with improved capability to reduce the amount of colloidal haze that may form in a beverage as described herein.

“Reaction mass” as used herein refers to a composition comprising PVPP made by any conventional methods.

“Reduce” and “reducing” as used herein with respect to the formation of colloidal haze refer to a measurable decrease, even if only barely detectable, in the formation of colloidal haze up to and including the complete prevention of the formation of colloidal haze.

The inventor has determined that treating PVPP with dilute aqueous hydrogen peroxide provides PVPP with improved capability to absorb and/or remove polyphenolic flavonoids from beer or other beverages. The PVPP with improved capability to absorb and/or remove polyphenolic flavonoids may be useful for treating beverages to reduce the amount of colloidal haze that may form in the beverages.

### Methods of Producing PVPP With Improved Capability to Absorb and/or Remove Polyphenols

Various embodiments of the present invention provide for methods of producing compositions comprising a polymer with improved capability to absorb and/or remove polyphenols and/or with improved capability to reduce the amount of colloidal haze that may form in a beverage. In one embodiment, the polyphenols may comprise polyphenolic flavonoids.

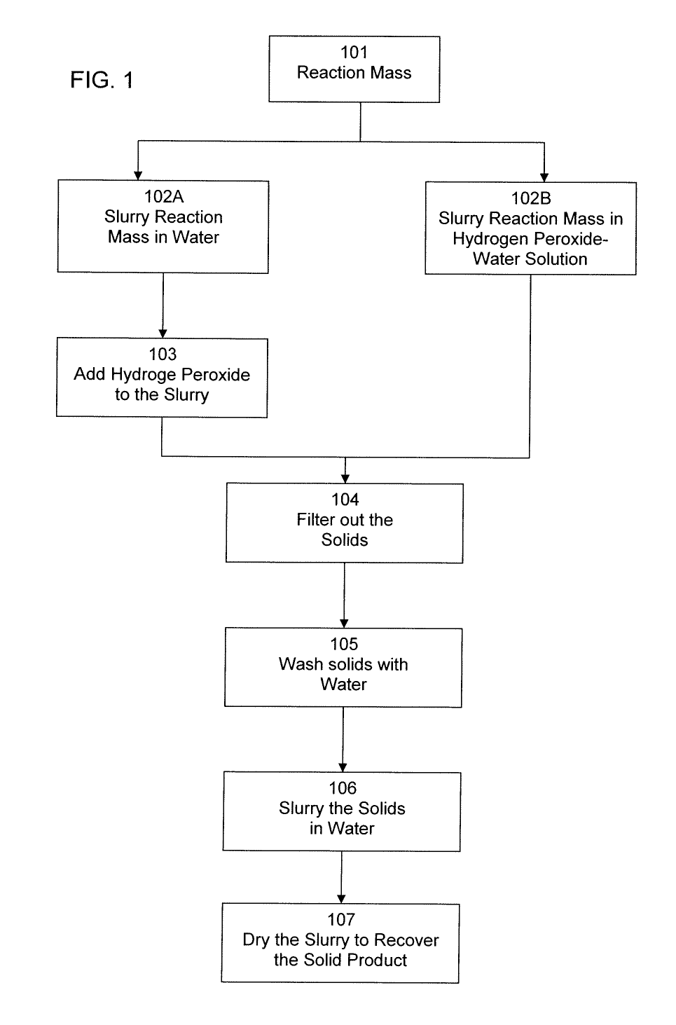

In one embodiment, the method comprises adding a quantity of hydrogen peroxide when the reaction mass is initially slurried in water. In another embodiment, the method comprises slurrying the reaction mass in a hydrogen peroxide-water solution. In one embodiment, the quantity of hydrogen peroxide may be a quantity that brings the concentration of hydrogen peroxide to between about 0.5% to about 5%. In another embodiment, the quantity of hydrogen peroxide may be a quantity that brings the concentration of hydrogen peroxide to between about 1% to about 3%. The hydrogen peroxide concentrations are not limited to the ranges set forth above; in alternate embodiments, quantities of hydrogen peroxide that brings the concentration of hydrogen peroxide less than 0.5% or more than 5% may also be used. In one embodiment, as depicted in FIG. 1, the method comprises step 101 of providing the reaction mass; step 102A of slurrying the reaction mass in water and step 103 of adding hydrogen peroxide to the slurry, or step 102B of slurrying the reaction mass in a hydrogen peroxide-water solution; step 104 of filtering out the solids; step 105 of washing the solids with water to remove impurities; step 106 of slurrying the solids in water; and step 107 of drying the slurry to recover the solid product. In one embodiment, the slurries may comprise between about 10% and about 20% solids. In another embodiment, the slurries may comprise between about 15% and about 18% solids. In a particular embodiment, the slurries may comprise about 15% solids. Concentration of solids in the slurries are not limited to the ranges or values set forth above; in alternate embodiments, slurries comprising less than 10% solid or slurries comprising more than 20% solids may also be used in accordance with the present invention. Drying the slurry may be done by any conventional method. In one embodiment drying the slurry may comprise placing the slurry in a spray dryer and recovering a dry solid product. The solid product comprises the PVPP with improved capability to absorb and/or remove polyphenols.

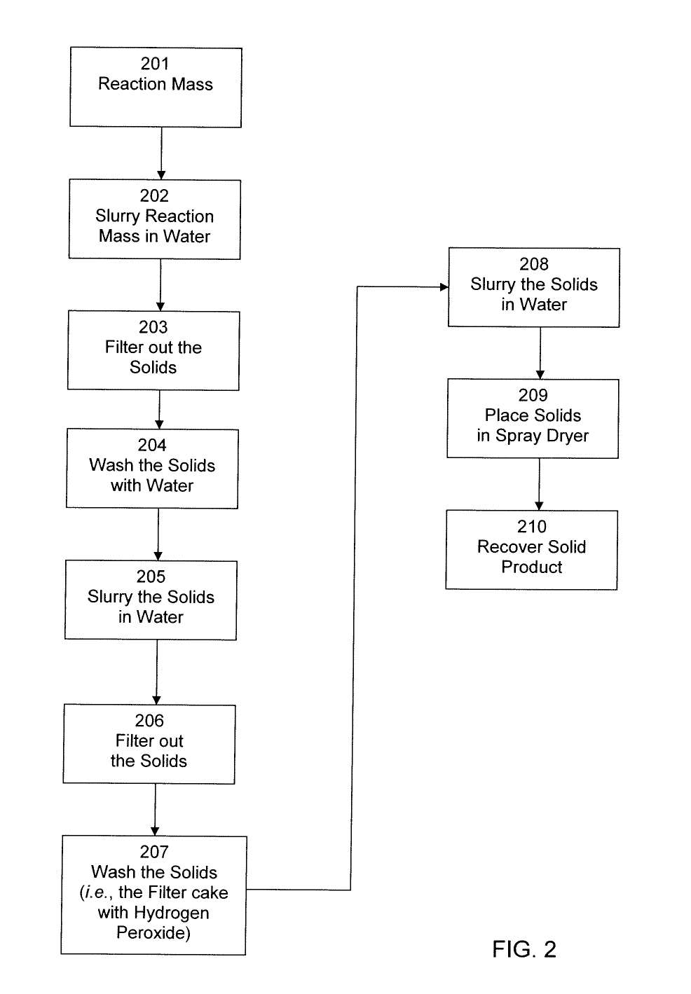

In another embodiment, the method comprises washing the filter cake that is generated after the second slurry is filtered with a quantity of hydrogen peroxide. In one embodiment, the quantity of hydrogen peroxide may be a quantity that brings the concentration of hydrogen peroxide to between about 0.5% to about 5% after the filter cake is reslurried with water. In another embodiment, the quantity of hydrogen peroxide may be a quantity that brings the concentration of hydrogen peroxide to between about 1% to about 3% after the filter cake is reslurried with water. The hydrogen peroxide concentrations are not limited to the ranges set forth above; in alternate embodiments, quantities of hydrogen peroxide that brings the concentration of hydrogen peroxide less than 0.5% or more than 5% after the filter cake is reslurried with water may also be used. In one embodiment, as depicted in FIG. 2, the method comprises: step 201 of providing a reaction mass; step 202 of slurrying the reaction mass in water; step 203 of filtering out the solids; step 204 of washing the solids with water to remove impurities; step 205 of slurrying the solids in water; step 206 of filtering out the solids; step 207 of washing the solids with hydrogen peroxide; step 208 of slurrying the solids in water; and step 209 of drying the slurry to recover the solid product. In one embodiment, the slurries may comprise between about 10% and about 20% solids. In another embodiment, the slurries may comprise between about 15% and about 18% solids. In a particular embodiment, the slurries may comprise about 15% solids. Concentration of solids in the slurries are not limited to the ranges or values set forth above; in alternate embodiments, slurries comprising less than 10% solid or slurries comprising more than 20% solids may also be used in accordance with the present invention. Drying the slurry may be done by any conventional method. In one embodiment drying the slurry may comprise placing the slurry in a spray dryer and recovering a dry solid product. The solid product comprises the PVPP with improved capability to absorb and/or remove polyphenols.

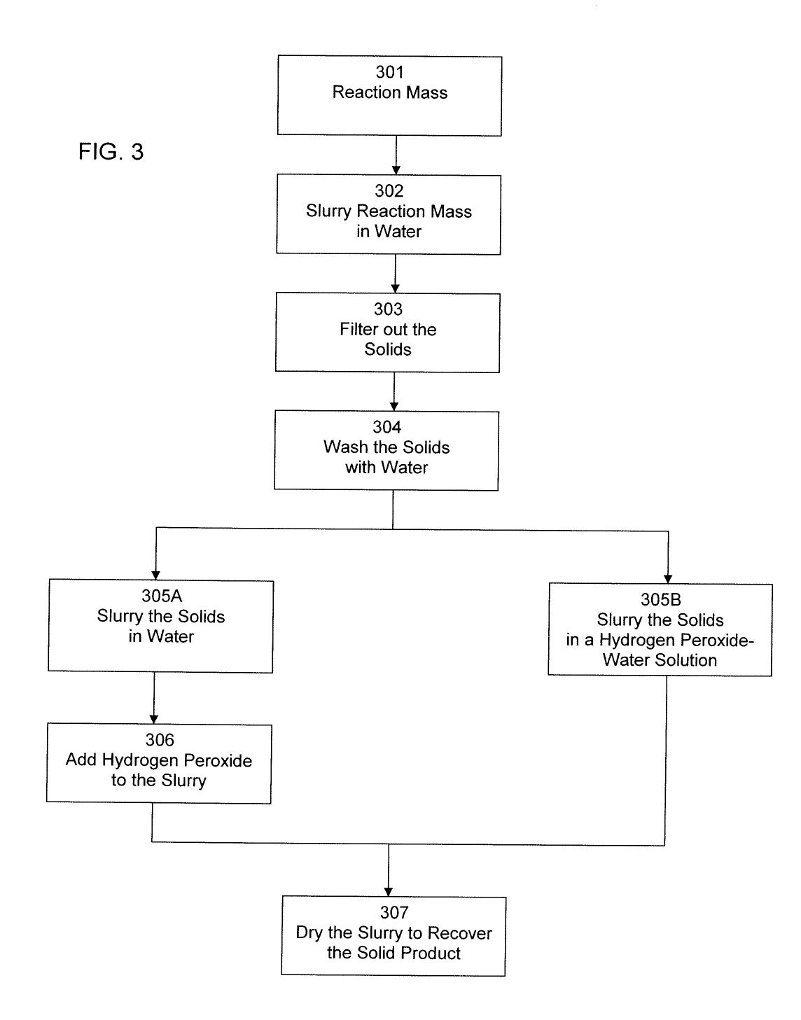

In another embodiment, the method may comprise adding a quantity of hydrogen peroxide after the filter cake is reslurried. In another embodiment, the method may comprise having the filter cake reslurried in a hydrogen peroxide-water solution. In one embodiment, the quantity of hydrogen peroxide may be a quantity that brings the concentration of hydrogen peroxide to between about 0.5% to about 5% in the slurry. In another embodiment, the quantity of hydrogen peroxide may be a quantity that brings the concentration of hydrogen peroxide to between about 1% to about 3% in the slurry. The hydrogen peroxide concentrations are not limited to the ranges set forth above; in alternate embodiments, quantities of hydrogen peroxide that brings the concentration of hydrogen peroxide less than 0.5% or more than 5% in the slurry may also be used. In one embodiment, as depicted in FIG. 3, the method comprises: step 301 of providing a reaction mass; step 302 of slurrying the reaction mass in water; step 303 of filtering out the solids; step 304 of washing the solids (e.g., the filter cake) with water to remove impurities; step 305A of slurrying the solids (e.g., the filter cake) in water and step 306 of adding hydrogen peroxide to the slurry, or step 305B of slurrying the solids in a hydrogen peroxide-water solution; and step 307 of drying the slurry to recover the solid product. In one embodiment, the slurries may comprise between about 10% and about 20% solids. In another embodiment, the slurries may comprise between about 15% and about 18% solids. In a particular embodiment, the slurries may comprise about 15% solids. Concentration of solids in the slurries are not limited to the ranges or values set forth above; in alternate embodiments, slurries comprising less than 10% solid or slurries comprising more than 20% solids may also be used in accordance with the present invention. Drying the slurry may be done by any conventional method. In one embodiment drying the slurry may comprise placing the slurry in a spray dryer and recovering a dry solid product. The solid product comprises the PVPP with improved capability to absorb and/or remove polyphenols.

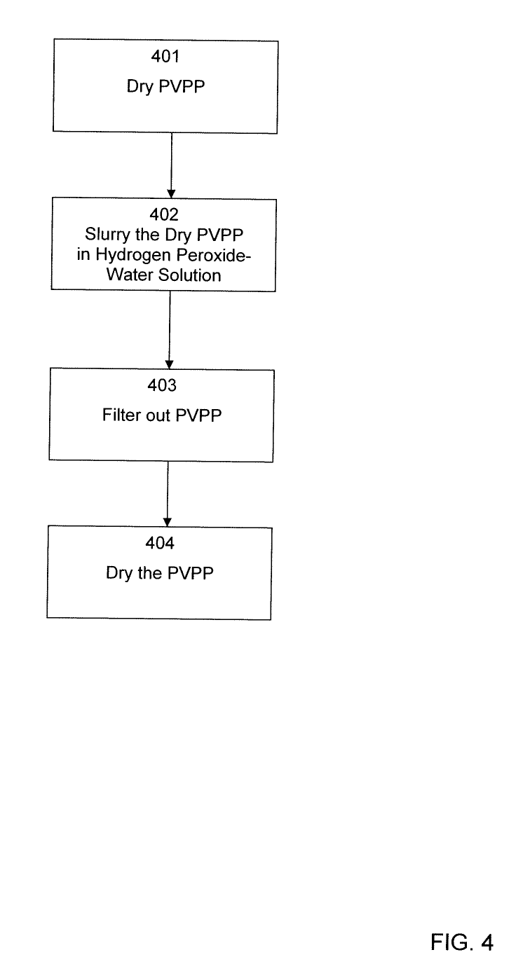

In another embodiment, the method may comprise treating the final dry product by slurrying it in a solution comprising a quantity of hydrogen peroxide. In one embodiment, the quantity of hydrogen peroxide may be a quantity of hydrogen peroxide to bring the slurry to about 0.5% to about 5% of hydrogen peroxide. In another embodiment, the quantity of hydrogen peroxide may be a quantity of hydrogen peroxide to bring the slurry to about 1% to about 3% of hydrogen peroxide. The hydrogen peroxide concentrations are not limited to the ranges set forth above; in alternate embodiments, quantities of hydrogen peroxide that brings the concentration of hydrogen peroxide less than 0.5% or more than 5% may also be used. The slurry is filtered and the solids are dried. In one embodiment, as depicted in FIG. 4, the method comprises: step 401 of providing dry PVPP; step 402 of slurrying the dry PVPP in a hydrogen peroxide-water solution; step 403 of filtering out the PVPP; and step 404 of drying the PVPP. Drying the slurry may be done by any conventional method. In one embodiment drying the slurry may comprise placing the slurry in a spray dryer and recovering a dry solid product. The solid product comprises the PVPP with improved capability to absorb and/or remove polyphenols.

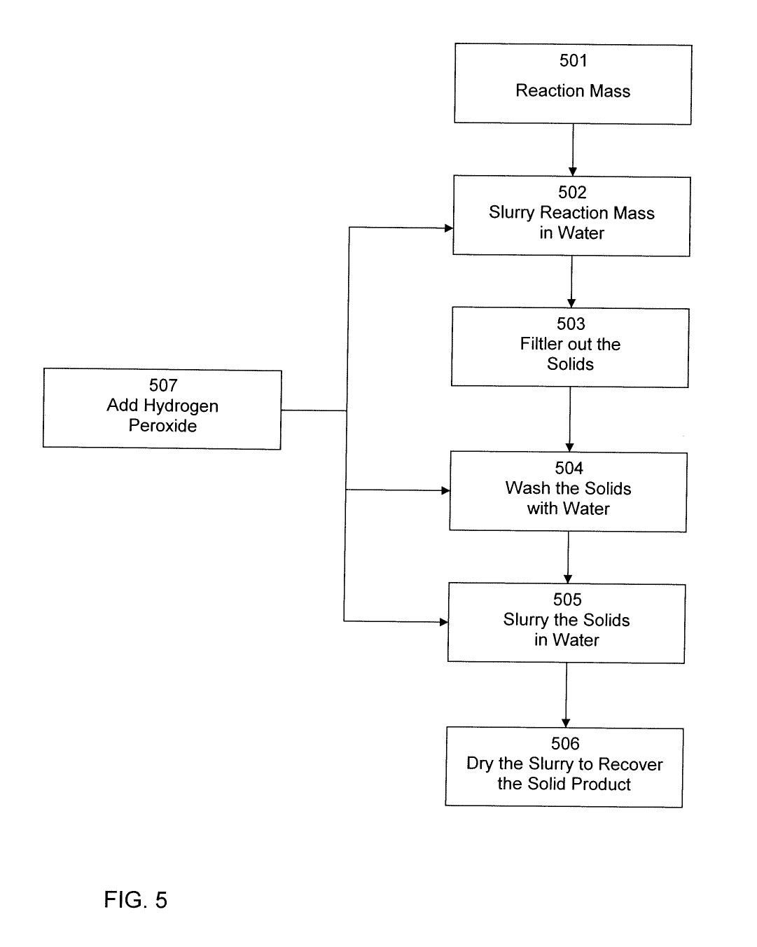

In another embodiment, the method comprises adding a quantity of hydrogen peroxide at one or more steps during the process of producing the PVPP. For example, as depicted in FIG. 5, a typical method of recovering the PVPP may comprise: step 501 of providing a reaction mass; step 502 of slurrying the reaction mass in water; step 503 of filtering out the solids; step 504 of washing the solids with water; step 505 of slurrying the solids in water; and step 506 of drying the slurry to recover the solid product. This method may further comprise step 507 of adding hydrogen peroxide during step 502, step 504, and/or step 505.

### Compositions Comprising PVPP with Improved Capability to Absorb and/or Remove Polyphenols

Other embodiments of the present invention provide for compositions comprising a polymer with improved capability to absorb and/or remove polyphenols and/or with improved capability to reduce the amount of colloidal haze that may form. In one embodiment the polyphenols may comprise polyphenolic flavonoids. The composition may be obtained by treating PVPP with hydrogen peroxide. In one embodiment, the hydrogen peroxide may be dilute hydrogen peroxide. In another embodiment, the hydrogen peroxide may be in an aqueous form. In another embodiment, the hydrogen peroxide may be in gaseous form. In a particular embodiment, the PVPP may be treated with dilute aqueous hydrogen peroxide.

Treating PVPP with hydrogen peroxide may be accomplished in by various methods as described herein.

In one embodiment, the method comprises adding a quantity of hydrogen peroxide when the reaction mass is initially slurried in water. In another embodiment, the method comprises slurrying the reaction mass in a hydrogen peroxide-water solution. See for example, FIG. 1. In one embodiment, the quantity of hydrogen peroxide may be a quantity that brings the concentration of hydrogen peroxide to between about 0.5% to about 5%. In another embodiment, the quantity of hydrogen peroxide may be a quantity that brings the concentration of hydrogen peroxide to between about 1% to about 3%. The hydrogen peroxide concentrations are not limited to the ranges set forth above; in alternate embodiments, quantities of hydrogen peroxide that brings the concentration of hydrogen peroxide less than 0.5% or more than 5% may also be used.

In another embodiment, the method comprises washing the filter cake that is generated after the second slurry is filtered with a quantity of hydrogen peroxide. See for example, FIG. 2. In one embodiment, the quantity of hydrogen peroxide may be a quantity that brings the concentration of hydrogen peroxide to between about 0.5% to about 5% after the filter cake is reslurried with water. In another embodiment, the quantity of hydrogen peroxide may be a quantity that brings the concentration of hydrogen peroxide to between about 1% to about 3% after the filter cake is reslurried with water. The hydrogen peroxide concentrations are not limited to the ranges set forth above; in alternate embodiments, quantities of hydrogen peroxide that brings the concentration of hydrogen peroxide less than 0.5% or more than 5% after the filter cake is reslurried with water may also be used.

In another embodiment, the method may comprise adding a quantity of hydrogen peroxide after the filter cake is reslurried. In another embodiment, the method may comprise having the filter cake reslurried in a hydrogen peroxide-water solution. See for example FIG. 3. In one embodiment, the quantity of hydrogen peroxide may be a quantity that brings the concentration of hydrogen peroxide to between about 0.5% to about 5% in the slurry. In another embodiment, the quantity of hydrogen peroxide may be a quantity that brings the concentration of hydrogen peroxide to between about 1% to about 3% in the slurry. The hydrogen peroxide concentrations are not limited to the ranges set forth above; in alternate embodiments, quantities of hydrogen peroxide that brings the concentration of hydrogen peroxide less than 0.5% or more than 5% in the slurry may also be used.

In another embodiment, the method may comprise treating the final dry product by slurrying it in a solution comprising a quantity of hydrogen peroxide. See for example FIG. 4. In one embodiment, the quantity of hydrogen peroxide may be a quantity of hydrogen peroxide to bring the slurry to about 0.5% to about 5% of hydrogen peroxide. In another embodiment, the quantity of hydrogen peroxide may be a quantity of hydrogen peroxide to bring the slurry to about 1% to about 3% of hydrogen peroxide. The hydrogen peroxide concentrations are not limited to the ranges set forth above; in alternate embodiments, quantities of hydrogen peroxide that brings the concentration of hydrogen peroxide less than 0.5% or more than 5% may also be used. The slurry is filtered to recover the polymer and the polymer is dried.

### Methods of Removing Polyphenols from a Beverage

Additional embodiments of the present invention provide for methods of removing polyphenols from a beverage. The removal of polyphenols may prevent and/or reduce colloidal haze in the beverage. In one embodiment, the polyphenols may comprise polyphenolic flavonoids. In one embodiment, the beverage may be beer. In another embodiment, the beverage may be wine.

In various embodiments, the method may comprise contacting the beverage with an inventive composition comprising PVPP with improved capability to absorb and/or remove polyphenols as described herein and removing the inventive composition. The PVPP with improved capability to absorb and/or remove polyphenols may be made by the inventive methods described herein. Contacting the beverage with a composition comprising a PVPP with improved capability to absorb and/or remove polyphenols may comprise adding the inventive composition comprising PVPP with improved capability to absorb and/or remove polyphenols to a container of the beverage. For example, about 5 to about 20 grams of the PVPP with improved capability to absorb and/or remove polyphenols may be added per hectoliter of beer. The mixture may be mixed for an amount of time for the PVPP to absorb and/or remove the polyphenols. The amount of time may depend on a variety of factors, including but not limited to the temperature, the mixing method, and the quantity of beer. In one embodiment, the amount of time may be about 30 minutes. After mixing, the beer may be filtered to remove the PVPP.

In other embodiments, dry PVPP with improved capability to absorb and/or remove polyphenols as described herein may be allowed to hydrate, and the hydrated PVPP may be added to the beverage. In one embodiment, hydrating the dry PVPP may be accomplished by slurrying it in water at an appropriate concentration for a sufficient period of time to allow it to hydrate. In one embodiment, the appropriate concentration may be about 8 to 12% solids. In one embodiment, the sufficient period of time may be a period of about 1 hour. Adding hydrated PVPP to the beverage may comprise adding the hydrated PVPP to the beverage to make a concentration of between about 5 and about 50 grams of PVPP per hectoliter of beer.

### Kits

Further embodiments of the present invention provide for kits for removing polyphenols from a beverage and/or reducing the amount of colloidal haze that may form in a beverage and/or kits for producing the inventive composition comprising a polymer with improved capability to absorb and/or remove polyphenols and/or with improved capability to reduce the amount of colloidal haze that may form as described herein. In one embodiment, the polyphenols may comprise polyphenolic flavonoids. The kit is an assemblage of materials or components.

Kits for removing polyphenols from a beverage may include at least one of the inventive compositions. Thus, in some embodiments the kit contains a composition including the PVPP with improved capability to absorb and/or remove polyphenols as described herein.

Kits for treating PVPP to produce a polymer with improved capability to absorb and/or remove polyphenols may include PVPP and hydrogen peroxide.

The exact nature of the components configured in the inventive kit depends on its intended purpose. For example, some embodiments are configured for the purpose of producing a polymer with improved capability to absorb and/or remove polyphenols. In other embodiments, the kits are configured for the purpose of removing polyphenolic flavonoids from a beverage. In one embodiment, the kit is configured particularly for the purpose of removing polyphenolic flavonoids from beer. In another embodiment, the kit is configured particularly for the purpose of removing polyphenolic flavonoids from wine.

Instructions for use may be included in the kit. “Instructions for use” typically include a tangible expression describing the technique to be employed in using the components of the kit to effect a desired outcome, such as to produce a polymer to absorb and/or remove polyphenols from a beverage, or to absorb and/or remove polyphenols from a beverage using the inventive composition described herein.

Instructions to produce a polymer to absorb and/or remove polyphenolic flavonoids from a beverage may include; for example, instructions to add a quantity of hydrogen peroxide to the PVPP or instructions to wash the PVPP with a quantity hydrogen peroxide.

Instructions to remove polyphenols from a beverage may include, for example, instructions to hydrate the PVPP with improved capability to absorb and/or remove polyphenols, instructions to add a quantity of the PVPP to the beverage, instructions to mix the mixture to remove polyphenols and/or instructions to filter the beverage to remove the PVPP.

Optionally, the kit also contains other useful components, such as, diluents, buffers, measuring tools, mixing tools, filters, or other useful materials as will be readily recognized by those of skill in the art.

The materials or components assembled in the kit can be provided to the user stored in any convenient and suitable ways that preserve their operability and utility. For example the components can be in a dehydrated, hydrated, or powdered form. The components are typically contained in suitable packaging material(s). As employed herein, the phrase “packaging material” refers to one or more physical structures used to house the contents of the kit, such as inventive compositions and the like. The packaging material is constructed by well known methods. The packaging material may be constructed to provide a sterile, contaminant-free environment. The packaging materials employed in the kit are those customarily utilized in food processing, such as beer or wine processing. As used herein, the term “package” refers to a suitable solid matrix or material such as glass, plastic, paper, foil, and the like, capable of holding the individual kit components. Thus, for example, a package can be a plastic bag used to contain suitable quantities of an inventive composition containing the inventive PVPP. The packaging material generally has an external label which indicates the contents and/or purpose of the kit and/or its components.

### EXAMPLE

The following example is provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

Example 1

The following were charged to a stirred vessel: 400 parts water, 90 parts PVPP (dry), 16 parts aqueous Hydrogen Peroxide (30%). The contents were mixed until the powder was thoroughly wetted. The contents were agitated for 2 hours. The contents were filtered, producing a filter cake. The filter cake was washed with water until the filtrate was neutral (pH 5 to 8). The wet cake was dried to less than 5% moisture.

The dry, treated PVPP was used to treat a sample of freshly brewed beer by adding 20 grams of PVPP per hectoliter of beer, mixing for 30 minutes and filtering out the PVPP.

As a control, a sample of untreated, commercially produced PVPP was used to treat the same batch of beer, also at 20 grams of PVPP per hectoliter of beer.

Both batches of beer were packaged in aluminum cans.

The cans were subjected to accelerated aging tests. One set of cans was stored in an oven at 40° C., the other at 60° C. At intervals, one can of the treated PVPP group and one of the untreated PVPP group (control) were taken out of their respective oven and held at room temperature. At the end of the test period all cans were chilled to 0° C. and held at that temperature for 24 hours. The cans were opened and the turbidity of the beer was measured using a Haffmans Hazemeter, the results are provided in EBC units.

The test results are summarized in tables 1 and 2.

TABLE 1

| DAYS AT 40° C. | PEROXIDE TREATED | UNTREATED |
|---|---|---|
| 0 (control) | 0.22 EBC | 0.22 EBC |
| 8 | 0.17 EBC | 0.20 EBC |
| 14 | 0.25 EBC | 0.36 EBC |
| 20 | 0.43 EBC | 0.92 EBC |

TABLE 2

| DAYS AT 60° C. | PEROXIDE TREATED | UNTREATED |
|---|---|---|
| 0 (control) | 0.30 EBC | 0.30 EBC |
| 1 | 0.25 EBC | 0.33 EBC |
| 2 | 0.40 EBC | 0.50 EBC |
| 3 | 0.50 EBC | 0.60 EBC |
| 4 | 0.90 EBC | 1.20 EBC |
| 5 | 0.95 EBC | 1.30 EBC |
| 6 | 1.00 EBC | 1.50 EBC |

In both accelerated aging tests, the beer stabilized with hydrogen peroxide treated PVPP retained its clarity longer than beer stabilized with untreated PVPP.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A method of producing a poly N-vinyl pyrrolidone (PVPP) with improved capability to absorb and/or remove polyphenols and/or with improved capability to reduce colloidal haze in a beverage (“improved PVPP”), comprising:
providing a composition comprising PVPP;
adding a quantity of hydrogen peroxide to the composition;
generating a slurry;
mixing the slurry; and
removing from the slurry, the improved PVPP.

2. The method of claim 1, wherein the polyphenols comprise a polyphenolic flavonoid.

3. The method of claim 1, wherein the composition comprising PVPP is selected from the group consisting of a reaction mass comprising PVPP, a filter cake comprising PVPP, a slurry comprising PVPP and combinations thereof.

4. The method of claim 3, further comprising washing the filter cake comprising PVPP with the quantity of hydrogen peroxide.

5. The method of claim 1, wherein the quantity of hydrogen peroxide brings the concentration of hydrogen peroxide in the slurry to from about 0.5% to about 5%.

6. The method of claim 1, wherein the quantity of hydrogen peroxide brings the concentration of hydrogen peroxide in the slurry to from about 1% to about 3%.

7. The method of claim 1, further comprising drying the improved PVPP.

8. A composition, comprising:
a poly N-vinyl pyrrolidone (PVPP) with improved capability to absorb and/or remove polyphenols and/or with improved capability to reduce colloidal haze in a beverage (“improved PVPP”), produced by a method comprising:
providing a composition comprising PVPP;
adding a quantity of hydrogen peroxide to the composition;
generating a slurry;
mixing the slurry; and
removing from the slurry, the improved PVPP.

9. The composition of claim 8, wherein the composition comprising PVPP is selected from the group consisting of a reaction mass comprising PVPP, a filter cake comprising PVPP, a slurry comprising PVPP and combinations thereof.

10. The composition of claim 9, wherein the method further comprises washing the filter cake comprising PVPP with the hydrogen peroxide.

11. The method of claim 8, wherein the quantity of hydrogen peroxide brings the concentration of hydrogen peroxide in the slurry to from about 0.5% to about 5%.

12. The composition of claim 8, wherein the quantity of hydrogen peroxide brings the concentration of hydrogen peroxide in the slurry to from about 1% to about 3%.

13. The composition of claim 8, wherein the method further comprises drying the improved PVPP.

14. A method of removing a polyphenol from a beverage and/or reducing colloidal haze in a beverage, comprising:
providing a composition comprising a poly N-vinyl pyrrolidone (PVPP) with improved capability to absorb and/or remove polyphenols and/or with improved capability to reduce colloidal haze in a beverage (“improved PVPP”), produced by a method comprising:
providing a composition comprising PVPP,
adding a quantity of hydrogen peroxide to the composition,
generating a slurry,
mixing the slurry, and
removing from the slurry, the improved PVPP;
adding to the beverage, a quantity of the composition comprising the improved PVPP;
mixing the composition comprising the improved PVPP and the beverage; and
removing from the beverage, the composition comprising the improved.

15. The method of claim 14, wherein the polyphenols comprise a polyphenolic flavonoid.

16. The method of claim 14, wherein the beverage is beer or wine.

17. The method of claim 14, wherein the composition comprising PVPP is selected from the group consisting of a reaction mass comprising PVPP, a filter cake comprising PVPP, a slurry comprising PVPP and combinations thereof.

18. The method of claim 17, wherein the method of producing the composition further comprises washing the filter cake comprising PVPP with the hydrogen peroxide.

19. The method of claim 14, wherein the quantity of hydrogen peroxide brings the concentration of hydrogen peroxide in the slurry to from about 0.5% to about 5%.

20. The method of claim 14, wherein the quantity of hydrogen peroxide brings the concentration of hydrogen peroxide in the slurry to from about 1% to about 3%.

21. The method of claim 14, wherein the method of producing the composition further comprises drying the improved PVPP.

22. A kit for producing a poly N-vinyl pyrrolidone (PVPP) with improved capability to absorb and/or remove polyphenols and/or with improved capability to reduce colloidal haze in a beverage (“improved PVPP”), comprising:
a quantity of PVPP;
a quantity of hydrogen peroxide; and
instructions to use the PVPP and the hydrogen peroxide to produce the composition comprising the improved PVPP.

23. The kit of claim 22, wherein the instructions comprise instructions to
add a quantity of hydrogen peroxide to the PVPP,
generating a slurry comprising the PVPP and the hydrogen peroxide,
mix the slurry comprising the PVPP and the hydrogen peroxide,
remove from the slurry, the improved PVPP, and
dry the improved PVPP.

24. The kit of claim 23, wherein the instructions further comprise instructions to wash the PVPP with the hydrogen peroxide.

25. The kit of claim 22, wherein the instructions to add the quantity of hydrogen peroxide comprise instructions to add a quantity of hydrogen peroxide that brings the concentration of hydrogen peroxide in the slurry to from about 0.5% to about 5%.

26. The kit of claim 23, wherein the instructions to add the quantity of hydrogen peroxide comprise instructions to add a quantity of hydrogen peroxide that brings the concentration of hydrogen peroxide in the slurry to from about 1% to about 3%.

27. A kit for removing a polyphenol from a beverage and/or reducing colloidal haze in a beverage, comprising:
providing a composition comprising a poly N-vinyl pyrrolidone (PVPP) with improved capability to absorb and/or remove polyphenols and/or with improved capability to reduce colloidal haze in a beverage (“improved PVPP”) produced by a method comprising:
providing a composition comprising PVPP,
adding a quantity of hydrogen peroxide to the composition,
generating a slurry,
mixing the slurry, and
removing from the slurry, the improved PVPP; and
instructions to use the composition comprising the improved PVPP to remove the polyphenol from the beverage and/or reduce colloidal haze in the beverage.

28. The kit of claim 27, wherein the method of producing the composition further comprises washing the composition comprising PVPP with the hydrogen peroxide.

29. The kit of claim 27, wherein the instructions comprise instructions to
add to the beverage, a quantity of the composition comprising the improved PVPP,
mix the composition comprising the improved PVPP and the beverage, and
remove from the beverage, the composition comprising the improved PVPP.

30. The kit of claim 27, wherein the polyphenol comprises a polyphenolic flavonoid.

31. The kit of claim 27, wherein the beverage is beer or wine.
